(19) United States
(12) Patent Application Publication
(10) Pub. No.: US 2024/0241151 A1
(43) Pub. Date: Jul. 18, 2024

(54) SYSTEM FOR PERFORMING ATOMIC FORCE MICROSCOPY, INCLUDING A GRID PLATE QUALIFICATION TOOL

(71) Applicant: Nearfield Instruments B.V., Rotterdam (NL)

(72) Inventors: Hamed SADEGHIAN MARNANI, Rotterdam (NL); Ioan-Andrei TOACSEN, Eindhoven (NL)

(21) Appl. No.: 18/289,407

(22) PCT Filed: May 18, 2022
(86) PCT No.: PCT/NL2022/050265

§ 371 Date: Nov. 3, 2023

(30) Foreign Application Priority Data
May 19, 2021 (NL) 2028248

(51) Int. Cl. G01Q 30/06; G01Q 40/02

(52) U.S. Cl. CPC G01Q 30/06; G01Q 40/02

(57) ABSTRACT

An atomic force microscopy tool (AFM) configured for receiving a plate including a coordinate reference pattern on the plate, for providing a position reference for the AFM: and a device for qualifying a coordinate reference pattern in the AFM, comprising a fixed reference frame, a pattern encoder for reading the reference pattern, an actuation stage for relatively moving the plate and the pattern encoder parallel to the plate, a displacement measurement system for measuring a displacement of the plate or pattern encoder relative to the fixed reference frame, and a controller for controlling the actuation stage, the encoder, and the measurement system, arranged to identify imperfections in the coordinate reference pattern and their locations by controlling the displacement measurement system; and arranged for storing each imperfection coupled to the location determined.

### FIELD OF THE INVENTION

The invention relates to a system for performing atomic force microscopy, the system comprising an atomic force microscopy tool configured for receiving a plate including a coordinate reference pattern on the plate, for providing a position reference for system elements of the atomic force microscopy tool. The system further comprises a device for qualifying the coordinate reference pattern on the plate, the device being arranged for receiving the plate such as to perform qualification inspection.

### BACKGROUND OF THE INVENTION

Various production and quality inspection systems require a highly accurate positioning of a production system element or an inspection system element relative to a product to be processed. Examples thereof are systems for manufacturing electronic, optic or opto-electric products at a nano-scale.

Positioning systems that operate at this scale, such as in scanning probe microscopy (SPM), commonly use an encoder in combination with a flat 2D encoder plate, also known as a grid plate, to determine a position reference for system elements while processing the product. The resolution and quality of the grid plate therefore largely contributes to the resolution and accuracy of the positioning system.

Depending on the patterning method, the grid plate pattern will have manufacturing imperfections. The manufacturing imperfections will lead to signal imperfections, limiting the accuracy of the position signal obtained from the encoder. Accordingly, there is a need for measures enabling an improved accuracy.

### SUMMARY OF THE INVENTION

In summary, embodiments of the invention pertain to a system for performing atomic force microscopy, the system comprising an atomic force microscopy tool configured for receiving a plate including a coordinate reference pattern on the plate, for providing a position reference for system elements of the atomic force microscopy tool. The system further comprises a device for qualifying the coordinate reference pattern on the plate, the device being arranged for receiving the plate such as to perform qualification inspection.

The device for qualifying the coordinate reference pattern on the plate for use in the atomic force microscopy (AFM) tool comprises a fixed reference frame, a pattern encoder, an actuation stage, a displacement measurement system, and a controller. The pattern encoder is arranged for reading the coordinate reference pattern on the plate. The actuation stage is arranged for moving the plate and the pattern encoder relative to each other in a direction parallel to the plane of the plate. The displacement measurement system is arranged for measuring a displacement of the plate or the pattern encoder relative to the fixed reference frame, and the controller is arranged for controlling the actuation stage, the pattern encoder, and the displacement measurement system.

While controlling the actuation stage, the controller is arranged for controlling the pattern encoder to identify imperfections in the coordinate reference pattern. For each imperfection, the controller is arranged for identifying the location of said imperfection by controlling the displacement measurement system to measure the displacement of the plate or the pattern encoder relative to the fixed reference frame. The controller is arranged for storing each imperfection coupled to the location of said each imperfection.

The benefit of the device is that the location of each imperfection identified by the pattern encoder is measured by an independent measurement system, e.g. with a higher measurement resolution than the pattern encoder, preferably at sub-micron scale, to qualify the coordinate reference pattern.

The invention also relates to a device for use in the system described above.

Other aspects of the invention relate to a data file for use in an atomic force microscopy (AFM) tool, generated by a device as described above. The data file comprises an array of identified imperfections in at least a subset of a coordinate reference pattern on a plate. Each identified imperfection is coupled to a location of said identified imperfection relative to at least one reference position on the coordinate reference pattern.

As a result, the data file may comprise a correction map of the coordinate reference pattern which can be used to improve the accuracy of the coordinate reference pattern when implemented in an AFM tool.

Yet other aspects of the invention pertain to a method of qualifying a coordinate reference pattern on a plate for use in an atomic force microscopy (AFM) tool by a device. In a first step, the method comprises moving, by an actuation stage, the plate and a pattern encoder relative to each other in a direction parallel to the plane of the plate. In a further step, the pattern encoder, which is arranged for reading the coordinate reference pattern on the plate, identifies imperfections in the coordinate reference pattern. Next, a displacement measurement system, which is arranged for measuring a displacement of the plate relative to a fixed reference frame, identifies a location of each imperfection. Finally, the method comprises storing each imperfection coupled to the location of said each imperfection, to create a pattern correction map.

### BRIEF DESCRIPTION OF THE DRAWINGS

The invention will be further elucidated in the figures:

FIG. 1 illustrates a first embodiment of a device 10 for qualifying a coordinate reference pattern on a plate for use in an atomic force microscopy (AFM) tool;

FIG. 2 provides a top view of another or further embodiment of the device 10;

FIG. 3 illustrates the device 10 according to yet another or further embodiment;

FIG. 4 illustrates an example embodiment of the device 10;

FIG. 5 illustrates a data file 20 for use in an atomic force microscopy (AFM) tool generated by the device 10;

FIG. 6 provides a schematic overview of a method 30 of qualifying a coordinate reference pattern on a plate for use in an atomic force microscopy (AFM) tool by a device;

FIG. 7 illustrates a system for performing scanning probe microscopy in accordance with an embodiment of the invention.

### DETAILED DESCRIPTION

Aspects of the invention relate to a device and method for qualifying a coordinate reference pattern on a plate for use in an atomic force microscopy (AFM) tool, and to a data file for use in an atomic force microscopy (AFM) tool, generated by the device. The device and method comprise a fixed reference frame, a pattern encoder arranged for reading the coordinate reference pattern on the plate, an actuation stage arranged for moving the plate and the pattern encoder relative to each other in a direction parallel to the plane of the plate, a displacement measurement system arranged for measuring a displacement of the plate or the pattern encoder relative to the fixed reference frame, and a controller arranged for controlling the actuation stage, the pattern encoder, and the displacement measurement system.

While controlling the actuation stage, the controller is arranged for controlling the pattern encoder to identify imperfections in the coordinate reference pattern. The controller is arranged for identifying, for each imperfection, the location of said each imperfection by controlling the displacement measurement system to measure the displacement of the plate or the pattern encoder relative to the fixed reference frame. The controller is arranged for storing each imperfection coupled to the location of said each imperfection. The benefit of the device and method is that the location of each imperfection identified by the pattern encoder is measured by an independent measurement system, e.g. with a higher measurement resolution than the pattern encoder, to qualify the coordinate reference pattern.

In a preferred embodiment of the device, the controller is arranged for identifying imperfections in at least a subset of the coordinate reference pattern, to create a pattern correction map which can e.g. be used to improve the positioning accuracy of an AFM.

In other or further embodiments of the device, prior to controlling the pattern encoder to identify imperfections, the controller is arranged for controlling the pattern encoder to identify at least one reference position in the coordinate reference pattern, and, for each reference position, identifying the location of said reference position by controlling the displacement measurement system to measure the displacement of the plate relative to the fixed reference frame, and storing each reference position coupled to the location of said each reference position, to provide a map of identified reference positions on the coordinate reference pattern coupled to the identified imperfections, which can e.g. be used by an AFM tool to quickly scan which coordinate reference pattern or plate is used.

Additionally, for each imperfection, the controller can be arranged for calculating the relative location of said each imperfection relative to at least one reference position, and storing each imperfection coupled to the relative location of said each imperfection, to improve the accuracy of the correction map.

In some embodiments, for each imperfection, the controller is arranged for controlling the pattern encoder to identify a type of imperfection and/or to quantify an effect of said each imperfection, and for storing each imperfection coupled to the location of said each imperfection and the type and/or quantified effect of said each imperfection, to create a pattern correction map that also provides information about the type and effect of each identified imperfection, which may improve the robustness of the coordinate reference pattern.

In other or further preferred embodiments, the controller is arranged for controlling the displacement measurement system to measure the displacement of the plate along an X-axis defined by the fixed reference frame, and along a Y-axis perpendicular to the X-axis. The controller can additionally be arranged for controlling the displacement measurement system to measure a rotation of the plate around a Z-axis, perpendicular to the X-axis and the Y-axis, such that the coordinates provided by the correction map can be aligned with the coordinates as measured by the AFM tool to improve ease of implementation.

In some embodiments, the actuation stage is arranged for adjusting a position of the plate along the Z-axis, and for adjusting an orientation of the plate around the X-axis and around the Y-axis, and wherein the displacement measurement system is additionally arranged for measuring a displacement of the plate along the Z-axis, to minimize installation errors. Additionally, while controlling the actuation stage to move the plate and the pattern encoder relative to each other in a direction parallel to the plane of the plate, the controller can be arranged for controlling the actuation stage to maintain the position and orientation of the plate along the Z-axis, and around the X-axis and Y-axis, respectively, to minimize measurement errors during movement of the plate.

In a preferred embodiment of the device, the displacement measurement system comprises a laser-interferometer system, to measure the displacement of the actuation stage with sub-micron resolution.

In another or further preferred embodiment, the actuation stage comprises planar air bearings for moving the plate, to minimize friction while moving the plate.

Preferably, the actuation stage and the fixed reference frame are mechanically and thermally isolated from each other, to avoid forces and/or thermal effects influencing the measurement.

In some embodiments, the device comprises an enclosure to provide a conditioned environment for at least the fixed reference frame and the actuation stage.

The invention is described more fully hereinafter with reference to the accompanying drawings, in which embodiments of the invention are shown. In the drawings, the absolute and relative sizes of systems, components, layers, and regions may be exaggerated for clarity.

Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

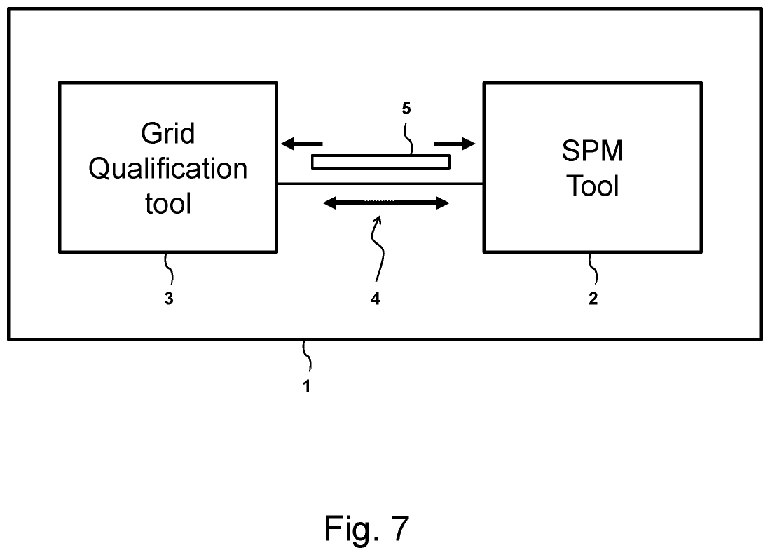

Now turning to FIG. 7, a system 1 for performing scanning probe microscopy (such as atomic force microscopy) in accordance with the invention is illustrated. The system 1 includes a scanning probe microscopy tool 2 (such as an atomic force microscopy tool—hereinafter also designated with reference numeral 2). The system also includes a grid qualification tool 3, or otherwise referred to as device for qualifying a coordinate reference pattern. The grid qualification tool 3 may for example be formed by or include the device 10 described further below. Furthermore, optionally an automatic or semiautomatic transport arrangement 4 may be included in the system 1 for enabling to convey a plate 5 including a coordinate reference pattern 210 between the atomic force microscopy tool 2 and the device 10 forming the grid qualification tool 3. This arrangement 4 is optional because the plate 5 may also be conveyed manually between the tools 2 and 3. For example, the system 1 may comprise the tools 2 and 3 closely arranged near each other such as to allow the plates 5 to be easily conveyed between the tools (with or without the arrangement 4), or occasionally the grid qualification tool 3 may be remotely located from the atomic force microscopy tool 2 and may not even be in the same building. In this latter embodiment, manual transportation of the plate 5 between the tools 2 and 3 is preferred. The grid qualification tool 3, e.g. in the form of any of the devices 10 described herein, may be a stand alone tool without the presence of the atomic force microscopy tool 2 and thus not forming the system 1.

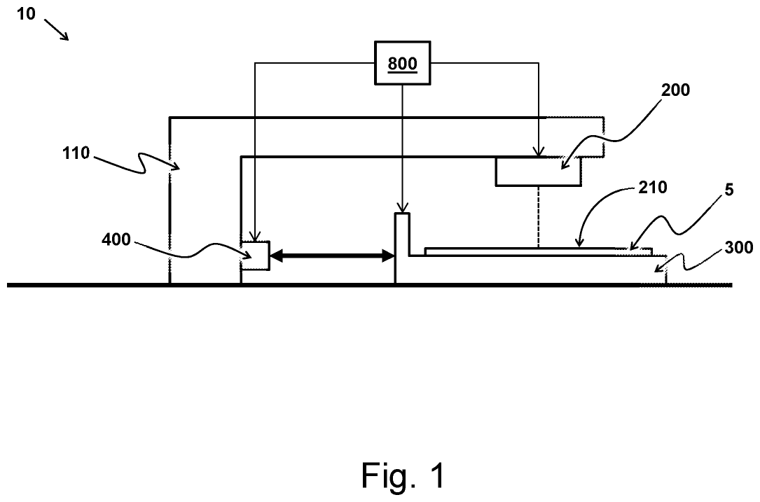

In FIG. 1, there is shown a device 10 for qualifying a coordinate reference pattern 210 on a plate 5, e.g. a grid plate, for use in an atomic force microscopy (AFM) tool. The device 10 comprises a fixed reference frame 110, such as a metrology frame. A pattern encoder 200 is arranged for reading the coordinate reference pattern 210 on the plate. The device 10 further comprises an actuation stage 300, arranged for moving the plate 5 and the pattern encoder 200 relative to each other in a direction parallel to the plane of the plate 5. The device 10 is arranged for receiving the plate 5 such as to perform qualification inspection, e.g. by enabling (manual, automatic or semiautomatic) mounting of the plate 5 to e.g. the actuation stage 300 or to the fixed reference frame 110, as explained further below. The pattern encoder 200 is e.g. mounted or suspended to the fixed reference frame 110 at a distance from the plate 5, or alternatively to the actuation stage 300 in case the plate is mounted to the fixed reference frame 110 in certain embodiments.

For example, the actuation stage 300 can be a one or two dimensional translation stage, in a cartesian coordinate frame, such as an x-y stage, or a polar coordinate frame, such as an r-θ stage. The actuation stage 300 can e.g. be arranged for moving the plate 5, while the pattern encoder 200 is mounted to the fixed reference frame 110. Alternatively, the actuation stage 300 can be arranged for moving the pattern encoder 200, while the plate 5 is mounted to the fixed reference frame 110.

In the device 10, a displacement measurement system 400 is arranged for measuring a displacement of the plate 5 or the pattern encoder 200 relative to the fixed reference frame 110, to measure the displacement of the actuation stage with sub-micron resolution. For example, the resolution of the displacement measurement system 400 is smaller than 500 nm, or between 10 and 300 nm, or between 50 and 200 nm. In FIG. 1 the displacement measurement system 400 shown is arranged for measuring a displacement of the plate 5 relative to the fixed reference frame 110. The displacement measurement system 400 can e.g. be based on an optical, magnetic, inductive, or a capacitive measurement principle, or any combination thereof. For example, the displacement measurement system 400 can be a laser-interferometer system, comprising e.g. one or more laser heads, interferometers and reflectors, or the displacement measurement system 400 can be a system of linear encoders comprising optical or magnetic scanning heads moving along graduated scales.

The device 10 further comprises a controller 800, arranged for controlling the actuation stage 300, the pattern encoder 200, and the displacement measurement system 400. The controller 800 can be an integral part of the device 10, or can be part of a computer system operatively connected to the device 10.

While controlling the actuation stage 300, the controller 800 is arranged for controlling the pattern encoder 200 to identify imperfections in the coordinate reference pattern 210. For each imperfection, the controller 800 is arranged for identifying the location of said imperfection by controlling the displacement measurement system 400 to measure the displacement of the plate 5 or the pattern encoder 200 relative to the fixed reference frame 110. The controller 800 is arranged for storing each imperfection coupled to the location of said each imperfection, e.g. in a computer readable memory which can be an integral part of the device 10, or can be part of a computer system operatively connected to the device 10.

In some embodiments, the controller 800 is arranged for identifying imperfections in at least a subset of the coordinate reference pattern 210, e.g. in the entire coordinate reference pattern 210, or in a specific area in the coordinate reference pattern 210, or in a number of distributed areas within the coordinate reference pattern 210, to create a pattern correction map.

Alternatively or additionally, the information about the imperfections may be stored in a data file or memory without creating a map. To enable correction of a position in view of an imperfection, at least a location of the imperfection may be stored. Any additional information will improve accuracy, but is optional to include in the data file or memory.

In other or further embodiments, the controller 800 is arranged for controlling the pattern encoder 200 to identify, for each imperfection, a type of imperfection, such as a geometrical deviation of the measured coordinate reference pattern 210 relative to an expected pattern, or a missing piece, or a scratch or other type of damage in the coordinate reference pattern 210.

Additionally or alternatively in these embodiments, the controller 800 is arranged for controlling the pattern encoder 200 to quantify, for each imperfection, an effect of said each imperfection, such as providing a quantified size, length or depth of the imperfection, or a quantification of the imperfection as a whole, e.g. including the shape or providing an indication of the usefulness of that area of the coordinate reference pattern 210.

Additionally, in these or other embodiments the controller 800 is arranged for storing each imperfection coupled to the location of said each imperfection and the type and/or quantified effect of said each imperfection. As such, a pattern correction map can be created that, besides the location, also provides information about the type and effect of each identified imperfection on the map, which may improve the robustness of the coordinate reference pattern such that e.g. an AFM tool is able to respond to each imperfection in the most appropriate way.

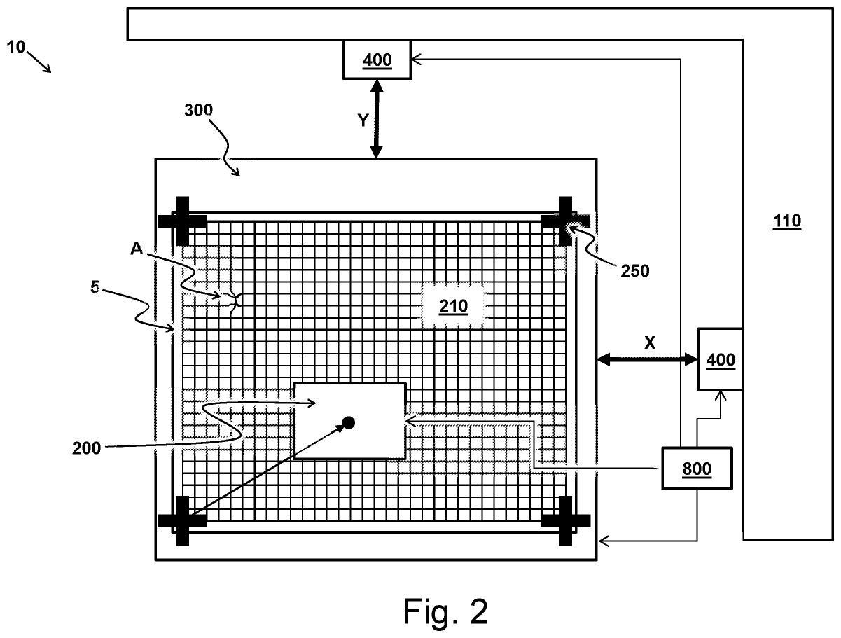

As shown in FIG. 2, the controller 800 can be arranged for controlling the pattern encoder 200 to identify at least one reference position 250 in the coordinate reference pattern 210, such as a predetermined position in the coordinate reference pattern 210, or a dedicated homing mark or fiducial, prior to controlling the pattern encoder 200 to identify imperfections. For each reference position 250, the controller 800 is arranged for identifying the location of said reference position by controlling the displacement measurement system 400 to measure the displacement of the plate 5 relative to the fixed reference frame 110, and storing each reference position 250 coupled to the location of said each reference position 250. This combination of identified reference positions 250 and imperfections can e.g. be used by an AFM tool to quickly scan which coordinate reference pattern 210 or plate 5 is used in the AFM tool.

In some further embodiments of the device 10, for each imperfection the controller 800 is arranged for calculating the relative location of said each imperfection relative to at least one reference position 250, and storing each imperfection coupled to the relative location of said each imperfection. For example, the controller 800 is arranged for calculating the relative location of imperfection A relative to three reference positions 250, and storing imperfection A coupled to the relative location of imperfection A relative to the three reference positions 250. A single reference position 250 could be sufficient, provided that its location on the plate 5 and its orientation are known. Multiple reference positions 250 improve accuracy.

Preferably, the relative location is calculated relative to at least two reference positions 250, for example relative to between two and four reference positions 250. In some embodiments, the controller 800 is arranged for deriving the relative location of each imperfection from the relative location calculated relative to at least two reference positions 250. For example, the controller 800 is arranged for deriving the relative location of imperfection A from the relative location calculated relative to four reference positions 250, e.g. by averaging the four relative locations. In this way, a more accurate pattern correction map can be obtained by the controller 800.

Preferably, as shown in FIG. 2, the controller 800 is arranged for controlling the displacement measurement system 400 to measure the displacement of the plate 5 along an X-axis defined by the fixed reference frame 110, and along a Y-axis perpendicular to the X-axis. In this way, the measured and stored location of each identified imperfection, and as such the coordinates provided by the correction map, can be aligned with the coordinates as measured by the AFM tool, to facilitate implementation of the correction map in the AFM tool e.g. by minimizing the need for geometrical transformations which could lead to servo delays and/or positioning errors. Preferably, the displacement measurement system 400 comprises adjustment means to adjust the orientation of the X-axis relative to the Y-axis such that they are perpendicular and intersect, to minimize measurement errors such as abbe errors.

In some further embodiments, the controller 800 is additionally arranged for controlling the displacement measurement system 400 to measure a rotation of the plate 5 around a Z-axis, perpendicular to the X-axis and the Y-axis. Preferably the displacement measurement system 400 comprises adjustment means to adjust the relative orientation between the X-axis, the Y-axis and the Z-axis, such that they are all perpendicular and intersect in one point, wherein the point preferably lies on the plane of the coordinate reference pattern 210, to minimize measurement errors such as abbe errors.

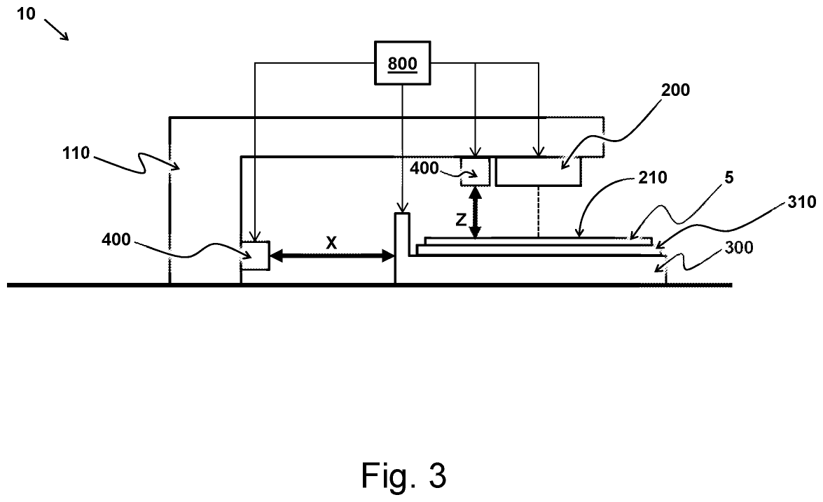

In other or further embodiments, as shown in FIG. 3, the actuation stage 300 is arranged for adjusting a position of the plate along the Z-axis, and for adjusting an orientation of the plate around the X-axis and around the Y-axis, and wherein the displacement measurement system is additionally arranged for measuring a displacement of the plate along the Z-axis. For example, the actuation stage 300 may comprise adjustment means 310 such as an adjustment mechanism comprising adjusting screws or actuators. By having an actuation stage arranged for adjusting the position and orientation of the plate 5 along the Z-axis and around the X- and Y-axis, installation errors such as encoder misalignment, cosine error and abbe error can be minimized.

Additionally, in some embodiments, while controlling the actuation stage 300 to move the plate 5 and the pattern encoder 200 relative to each other in a direction parallel to the plane of the plate 5, the controller 800 is arranged for controlling the actuation stage 300 to maintain the position and orientation of the plate 5 along the Z-axis, and around the X-axis and Y-axis, respectively, to minimize measurement errors such as cosine error and abbe error during movement of the plate 5 regardless of geometrical variations in the plate 5 and/or the actuation stage 300 or variations caused by dynamic or thermal effects.

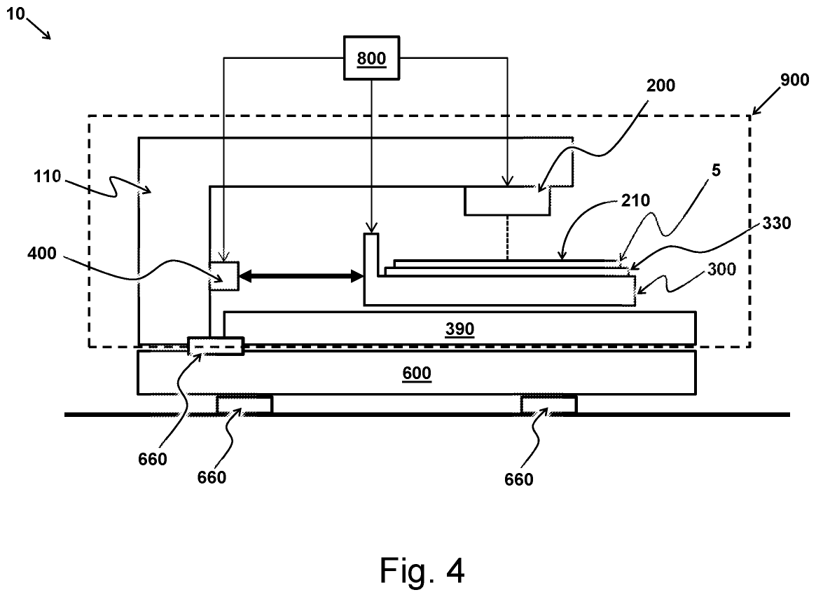

FIG. 4 illustrates an example embodiment of the device 10, wherein the displacement measurement system 400 comprises a laser-interferometer system, e.g. comprising one or more reflectors, interferometers and/or laser heads, preferably in an adjustable way to minimize measurement errors, e.g. related to the dead path of the laser light path or the cosine or abbe error. Preferably, the one or more reflectors of the system are mounted to the actuator stage 300, to minimize the moving mass. The one or more interferometers can for example be mounted to the fixed reference frame 110. Preferably the one or more laser heads are mounted at a distance from the fixed reference frame, e.g. by using a mirror or prism system, to avoid heat of the laser head influencing the measurement.

Good results can be achieved with a laser-interferometer system provided with a wavelength stability e.g. better than 0.02 ppm, a mirror flatness e.g. smaller than λ/10 and a mirror surface roughness e.g. better than 2 nanometers RMS, to create an accurate correction map. Besides the quality of these aspects, the accuracy of the correction map may also be dependent on other aspects, e.g. the resolution of the displacement measurement system, the quality of alignment of system components relative to each other, temperature stability, dynamic errors, etc. Repeatable measurement errors, such as those caused by mirror form imperfections or misalignment of components, can be compensated e.g. by taking into account results of a static or dynamic calibration routine of a displacement measurement system used to define a correction map, to further improve the accuracy of the correction map, e.g. better than 1 nanometer.

The laser-interferometer system can be arranged for measuring a two-dimensional displacement of the actuation stage 300, such as an x- and a y-displacement or an r- and θ-displacement, to measure the movement by the actuation stage 300 of the plate 5 and the pattern encoder 200 relative to each other in the direction parallel to the plane of the plate 5. Alternatively, the laser-interferometer system can be arranged for measuring a one- or three dimensional displacement of the actuation stage 300, to simplify the measurement or to verify the measurement relative to the fixed reference frame, respectively.

In some embodiments, the actuation stage 300 comprises planar air bearings 330 for moving the plate 5, to minimize friction between the actuation stage 300 and the plate 5 during movement which in turn reduces the amount of hysteresis, or virtual play. By minimizing (quasi-)static friction, stick-slip behavior can be reduced, which improves the overall positioning accuracy of the actuation stage 300. Alternatively, the actuation stage 300 can comprise other types of bearings for moving the plate with low friction, such as ball bearings, roller bearings or magnetic bearings. Alternatively, or additionally, the actuation stage 300 may comprise an elastic hinge mechanism for at least partially moving the plate 5 without friction and hysteresis. For example, the actuation stage 300 can provide the movement of the plate 5 by a two-stroke actuation mechanism having a large stroke comprising roller bearings and a small stroke comprising an elastic hinge mechanism.

In other or further embodiments, the actuation stage 300 and the fixed reference frame 110 are mechanically and thermally isolated from each other, to prevent forces or temperature changes originating from the actuation stage 300 affecting the fixed reference frame 110 and influencing the measurement. Preferably, the fixed reference frame 110 is designed as a metrology frame such that it is isolated from influences from other device components and from the environment. For example, the fixed reference frame 110 can have a heavy mass support structure 600, such as a granite base, to dampen out external forces. The support structure 600 in turn can be isolated from the ground by vibration isolators 660. As shown in FIG. 4, the actuation stage 300 can be mounted on a force frame 390 which is independently mounted to the support structure 600, and therefore mechanically and thermally isolated from the fixed reference frame 110. Optionally, a vibration isolator 660 can be added at the section where the force frame 390 and the fixed reference frame 110 are mounted to the support structure 600. Furthermore, the fixed reference frame 110 is preferably made of a low thermal expansion material, such as Zerodur, to limit thermal expansion, and preferably comprises components with matching thermal coefficient of expansion to avoid warping.

In some preferred embodiments, the device 10 comprises an enclosure 900 to provide a conditioned environment for at least the fixed reference frame 110 and the actuation stage 300. For example, the enclosure 900 may provide a steady temperature inside the enclosure 900, e.g. to reduce thermal expansion of the fixed reference frame 110 and/or the plate 5. The enclosure 900 may further provide a constant pressure inside the enclosure 900, e.g. to avoid fluctuations in the performance of planar air bearings 330 used by the actuation stage 300. The enclosure 900 may also provide constant lighting and humidity conditions for the pattern encoder 200 and/or the displacement measurement system 400, to avoid measurement errors due to optical aberrations or variations. Preferably, the enclosure 900 is also arranged for preventing dust or other particles from entering the enclosure 900 and contaminating e.g. the coordinate reference pattern 210 and/or the pattern encoder 200 and/or the displacement measurement system 400.

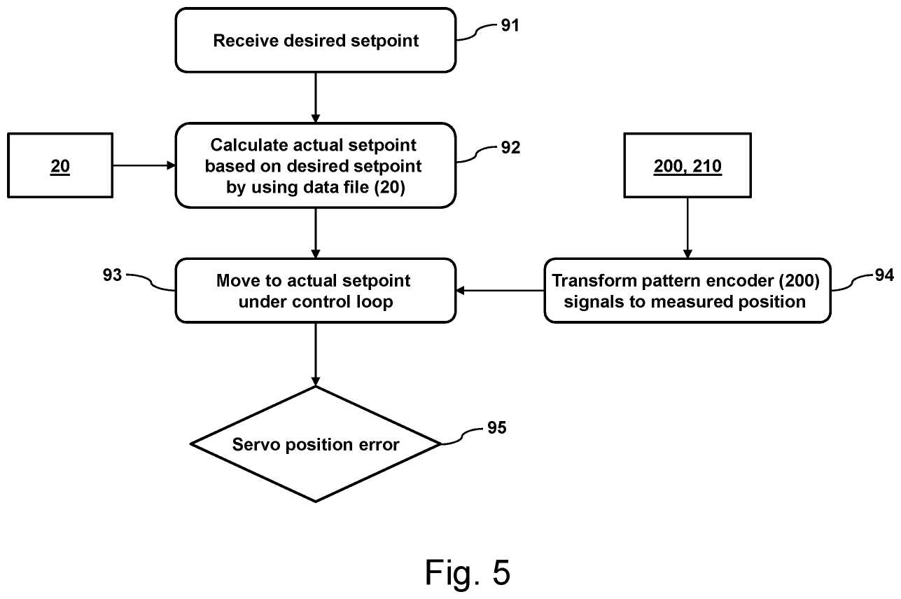

FIG. 5 illustrates a data file 20 for use in an atomic force microscopy (AFM) tool generated by the device 10 according to any of the embodiments of the present invention, e.g. as part of a real-time positioning strategy for an AFM or mini atomic force microscope (MAFM). FIG. 5 shows that the MAFM may initially receive a desired setpoint, in step 91, after which an actual setpoint is calculated in step 92 based on the desired setpoint by using the data file 20.

The data file 20 comprises an array of identified imperfections in at least a subset of a coordinate reference pattern 210 on a plate, such as a grid plate. The array of identified imperfections can for example be representative of the entire coordinate reference pattern 210, or be representative of a specific area in the coordinate reference pattern 210, or of a number of distributed areas or nodes within the coordinate reference pattern 210. In the data file 20, each identified imperfection is coupled to a location of said identified imperfection relative to at least one reference position on the coordinate reference pattern, such as a homing mark or a fiducial, thereby creating a correction map for the coordinate reference pattern 210.

For example, the data file may comprise an array of imperfections identified by a pattern encoder 200, covering a specific area in the coordinate reference pattern 210, with each imperfection coupled to an x- and y-location measured by a displacement measurement system 400 relative to a homing mark on the coordinate reference pattern 210. Alternatively, the data file 20 can comprise an array of imperfections identified by a pattern encoder, covering the entire coordinate reference pattern, with each imperfection coupled to an r- and θ-coordinate measured by a displacement reference system relative to two reference positions on the coordinate reference pattern.

As shown in FIG. 5, the MAFM tool can use the setpoint corrected by the data file 20 combined with the input from the pattern encoder 200 reading the coordinate reference pattern 210, wherein the signals of the pattern encoder 200 are transformed to a measured position in step 94, to move to the actual setpoint under a control loop in step 93, leading to a servo position error in step 95. The advantage of using the data file 20 to calculate the actual setpoint, is that it reduces the servo position error with respect to a system without such a data file 20. This can be explained by the data file 20 providing a correction map of the coordinate reference pattern 210, which serves as a calibrated feedforward signal for the control loop.

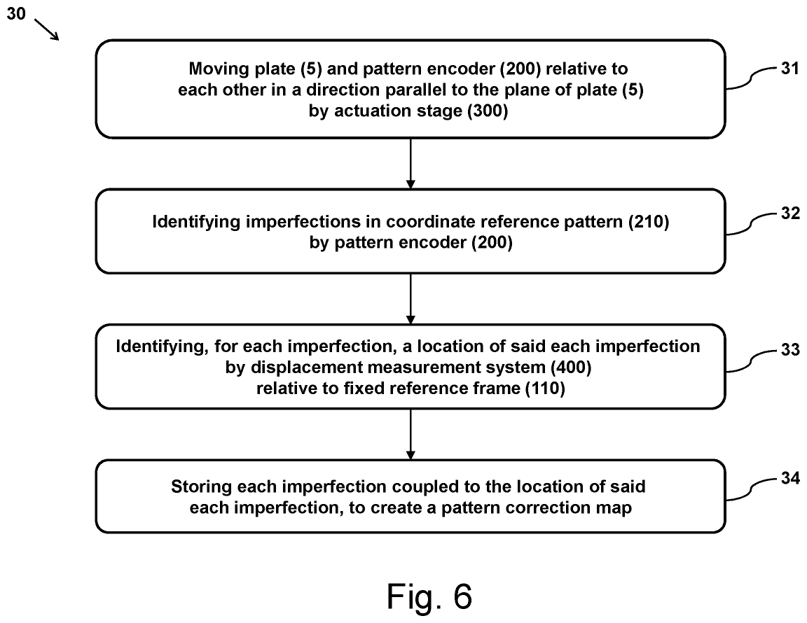

In FIG. 6 is shown a method 30 of qualifying a coordinate reference pattern 210 on a plate 5, e.g. a grid plate or grated disc, for use in an atomic force microscopy (AFM) tool by a device. The method comprises, in a first step 31, moving the plate 5 and a pattern encoder 200 relative to each other in a direction parallel to the plane of the plate 5 by an actuation stage 300. In a second step 32, imperfections are identified in the coordinate reference pattern 210 by the pattern encoder 210, which is arranged for reading the coordinate reference pattern 210 on the plate 5. In a third step 33, a location of said imperfection is identified by a displacement measurement system 400 for each imperfection. The displacement measurement system 400 is arranged for measuring a displacement of the plate 5 relative to a fixed reference frame 110. In a fourth step 34 each imperfection is coupled to the location of said each imperfection and stored, to create a pattern correction map.

Hereinafter, various characteristics of various embodiments of the invention will be highlighted in a set of numbered statements or paragraphs. These characteristics are not to be interpreted as being limiting on the invention or inventive concept, but are provided merely as a highlighting of some characteristics of the invention as described in the description, without suggesting a particular order of importance or relevancy of such characteristics. The invention is only limited by the appended claims presented in the correspondingly named section. The number statements include:
Statement 1: a device for qualifying a coordinate reference pattern on a plate for use in an atomic force microscopy (AFM) tool, comprising:
   a fixed reference frame;
   a pattern encoder, arranged for reading the coordinate reference pattern on the plate;
   an actuation stage, arranged for moving the plate and the pattern encoder relative to each other in a direction parallel to the plane of the plate;
   a displacement measurement system, arranged for measuring a displacement of the plate or the pattern encoder relative to the fixed reference frame; and
   a controller, arranged for controlling the actuation stage, the pattern encoder, and the displacement measurement system;
   wherein, while controlling the actuation stage, the controller is arranged for controlling the pattern encoder to identify imperfections in the coordinate reference pattern;
   wherein, for each imperfection, the controller is arranged for identifying the location of said each imperfection by controlling the displacement measurement system to measure the displacement of the plate or the pattern encoder relative to the fixed reference frame; and
   wherein the controller is arranged for storing each imperfection coupled to the location of said each imperfection.
Statement 2: device according to statement 1, wherein the controller is arranged for identifying imperfections in at least a subset of the coordinate reference pattern, to create a pattern correction map.
Statement 3: device according to any preceding statement, wherein, prior to controlling the pattern encoder to identify imperfections, the controller is arranged for controlling the pattern encoder to identify at least one reference position in the coordinate reference pattern, and, for each reference position, identifying the location of said reference position by controlling the displacement measurement system to measure the displacement of the plate relative to the fixed reference frame, and storing each reference position coupled to the location of said each reference position.
Statement 4: device according to statement 3, wherein, for each imperfection, the controller is arranged for calculating the relative location of said each imperfection relative to at least one reference position, and storing each imperfection coupled to the relative location of said each imperfection.
Statement 5: device according to any preceding statement, wherein, for each imperfection, the controller is arranged for controlling the pattern encoder to identify a type of imperfection and/or to quantify an effect of said each imperfection, and for storing each imperfection coupled to the location of said each imperfection and the type and/or quantified effect of said each imperfection.
Statement 6: device according to any preceding statement, wherein the controller is arranged for controlling the displacement measurement system to measure the displacement of the plate along an X-axis defined by the fixed reference frame, and along a Y-axis perpendicular to the X-axis.
Statement 7: device according to statement 6, wherein the controller is arranged for controlling the displacement measurement system to measure a rotation of the plate around a Z-axis, perpendicular to the X-axis and the Y-axis.
Statement 8: device according to any preceding statement, wherein the actuation stage is arranged for adjusting a position of the plate along the Z-axis, and for adjusting an orientation of the plate around the X-axis and around the Y-axis, and wherein the displacement measurement system is additionally arranged for measuring a displacement of the plate along the Z-axis.
Statement 9: device according to statement 8, wherein, while controlling the actuation stage to move the plate and the pattern encoder relative to each other in a direction parallel to the plane of the plate, the controller is arranged for controlling the actuation stage to maintain the position and orientation of the plate along the Z-axis, and around the X-axis and Y-axis, respectively.
Statement 10: device according to any preceding statement, wherein the displacement measurement system comprises a laser-interferometer system.
Statement 11: device according to any preceding statement, wherein the actuation stage comprises planar air bearings for moving the plate.
Statement 12: device according to any preceding statement, wherein the actuation stage and the fixed reference frame are mechanically and thermally isolated from each other.
Statement 13: Device according to any preceding statement, comprising an enclosure to provide a conditioned environment for at least the fixed reference frame and the actuation stage.
Statement 14: a data file for use in an atomic force microscopy (AFM) tool generated by the device according to any of the preceding statements, the data file comprising an array of identified imperfections in at least a subset of a coordinate reference pattern on a plate, wherein each identified imperfection is coupled to a location of said identified imperfection relative to at least one reference position on the coordinate reference pattern.
Statement 15: a method of qualifying a coordinate reference pattern on a plate for use in an atomic force microscopy (AFM) tool by a device, the method comprising:
   moving, by an actuation stage, the plate and a pattern encoder relative to each other in a direction parallel to the plane of the plate;
   identifying imperfections in the coordinate reference pattern by the pattern encoder, arranged for reading the coordinate reference pattern on the plate;
   identifying, for each imperfection, a location of said each imperfection by a displacement measurement system, arranged for measuring a displacement of the plate relative to a fixed reference frame; and
storing each imperfection coupled to the location of said each imperfection, to create a pattern correction map.

1. A system for performing atomic force microscopy, the system comprising:
an atomic force microscopy tool configured for receiving a plate including a coordinate reference pattern on the plate, for providing a position reference for system elements of the atomic force microscopy tool; and
a device for qualifying the coordinate reference pattern on the plate, the device being arranged for receiving the plate such as to perform qualification inspection, and comprising:
a fixed reference frame;
a pattern encoder, arranged for reading the coordinate reference pattern on the plate;
an actuation stage, arranged for moving the plate and the pattern encoder relative to each other in a direction parallel to the plane of the plate;
a displacement measurement system, arranged for measuring a displacement of the plate or the pattern encoder relative to the fixed reference frame; and
a controller, arranged for controlling the actuation stage, the pattern encoder, and the displacement measurement system;
wherein, while controlling the actuation stage, the controller is arranged for controlling the pattern encoder to identify imperfections in the coordinate reference pattern;
wherein, for each imperfection, the controller is arranged for identifying the location of said each imperfection by controlling the displacement measurement system to measure the displacement of the plate or the pattern encoder relative to the fixed reference frame; and
wherein the controller is arranged for storing each imperfection coupled to the location of said each imperfection.

2. The system according to claim 1, wherein the controller is arranged for identifying imperfections in at least a subset of the coordinate reference pattern, to create a pattern correction map.

3. The system according to claim 1, wherein, prior to controlling the pattern encoder to identify imperfections, the controller is arranged for controlling the pattern encoder to identify at least one reference position in the coordinate reference pattern, and, for each reference position, identifying the location of said reference position by controlling the displacement measurement system to measure the displacement of the plate relative to the fixed reference frame, and storing each reference position coupled to the location of said each reference position.

4. The system according to claim 3, wherein, for each imperfection, the controller is arranged for calculating the relative location of said each imperfection relative to at least one reference position, and storing each imperfection coupled to the relative location of said each imperfection.

5. The system according to claim 1, wherein, for each imperfection, the controller is arranged for controlling the pattern encoder to identify a type of imperfection and/or to quantify an effect of said each imperfection, and for storing each imperfection coupled to the location of said each imperfection and the type and/or quantified effect of said each imperfection.

6. The system according to claim 1, wherein the controller is arranged for controlling the displacement measurement system to measure the displacement of the plate along an X-axis defined by the fixed reference frame, and along a Y-axis perpendicular to the X-axis.

7. The system according to claim 6, wherein the controller is arranged for controlling the displacement measurement system to measure a rotation of the plate around a Z-axis, perpendicular to the X-axis and the Y-axis.

8. The system according to claim 1, wherein the actuation stage is arranged for adjusting a position of the plate along the Z-axis, and for adjusting an orientation of the plate around the X-axis and around the Y-axis, and wherein the displacement measurement system is additionally arranged for measuring a displacement of the plate along the Z-axis.

9. The system according to claim 8, wherein, while controlling the actuation stage to move the plate and the pattern encoder relative to each other in a direction parallel to the plane of the plate, the controller is arranged for controlling the actuation stage to maintain the position and orientation of the plate along the Z-axis, and around the X-axis and Y-axis, respectively.

10. The system according to claim 1, wherein the displacement measurement system comprises a laser-interferometer system.

11. The system according to claim 1, wherein the actuation stage comprises planar air bearings for moving the plate.

12. The system according to claim 1, wherein the actuation stage and the fixed reference frame are mechanically and thermally isolated from each other.

13. The system according to claim 1, comprising an enclosure to provide a conditioned environment for at least the fixed reference frame and the actuation stage.

14. A device for use in a system according to claim 1, for qualifying a coordinate reference pattern on a plate for use in an atomic force microscopy (AFM) tool.

15. A data file for use in an atomic force microscopy (AFM) tool generated by the device according to claim 14, the data file comprising an array of identified imperfections in at least a subset of a coordinate reference pattern on a plate, wherein each identified imperfection is coupled to a location of said identified imperfection relative to at least one reference position on the coordinate reference pattern.

16. A method of qualifying a coordinate reference pattern on a plate for use in an atomic force microscopy (AFM) tool by a device, the method comprising:
moving, by an actuation stage, the plate and a pattern encoder relative to each other in a direction parallel to the plane of the plate;
identifying imperfections in the coordinate reference pattern by the pattern encoder, arranged for reading the coordinate reference pattern on the plate;
identifying, for each imperfection, a location of said each imperfection by a displacement measurement system, arranged for measuring a displacement of the plate relative to a fixed reference frame; and
storing each imperfection coupled to the location of said each imperfection, to create a pattern correction map.
